(19) United States
(12) Patent Application Publication
(10) Pub. No.: US 2021/0211972 A1
(43) Pub. Date: Jul. 8, 2021

(54) Control of Search and/or Measurement Processes Based on Frequency Range Preference

(71) Applicant: Apple Inc., Cupertino, CA (US)

(72) Inventors: Wei Zhang, Santa Clara, CA (US); Alosious Pradeep Prabhakar, Singapore (SG); Pengkai Zhao, San Jose, CA (US); Vijay Venkataraman, San Jose, CA (US); Junsung Lim, San Jose, CA (US); Zhu Ji, San Jose, CA (US); Johnson O. Sebeni, Fremont, CA (US); Yu-Lin Wang, Fremont, CA (US); Galib A. Mohiuddin, San Diego, CA (US); Sriram Subramanian, Santa Clara, CA (US); Shiva Krishna Narra, San Jose, CA (US); Madhukar K. Shanbhag, Santa Clara, CA (US); Sanjeevi Balasubramanian, San Jose, CA (US); Daniel A. West, Mountain View, CA (US); Rohit R. Matolia, Surat (IN)

(21) Appl. No.: 17/084,387

(22) Filed: Oct. 29, 2020

(30) Foreign Application Priority Data
Jan. 3, 2020 (IN) 202041000336

(51) Int. Cl. H04W 48/16; H04W 24/10; H04W 52/02; H04W 4/02

(52) U.S. Cl. CPC H04W 48/16; H04W 24/10; H04W 88/02; H04W 4/027; H04W 52/0261

(57) ABSTRACT

A user equipment (UE) supports communication over a first (lower) frequency range and a second (higher) frequency range. The UE determines an extent of preference of the second frequency range over the first frequency range, e.g., based on one or more of the following: sensor measurements; physical channel measurements; battery conditions; weather conditions; voice call activity; indoor/outdoor/in-car status; learned relationships between previous location-time conditions and performance on the second frequency range; etc. The UE device may control search activity and/or measurement activity on the second frequency range based on the preference extent, e.g., by controlling rates of repetition of search and/or measurement on the second frequency range, or by adding a measurement bias to a measurement reporting threshold, or by adding a delay to a measurement reporting time for a measurement, or by disabling search and measurement on the second frequency range.

### FIELD

The present disclosure relates to the field of wireless communication, and more particularly, to mechanisms for determining a preference for one frequency range over another, and employing that preference to control measurement and/or search processes.

### DESCRIPTION OF THE RELATED ART

A user equipment (UE) device may be configured to communicate with a wireless network using a first frequency range and a second frequency range, where the second frequency range is higher in frequency than the first frequency range. (For example, the first frequency range may be the frequency range defined by 3GPP LTE or the FR1 frequency range defined by 5G NR. The second frequency range may be the FR2 frequency range defined by 5G NR.) The second frequency range may include one or more frequency bands in the millimeter wave region of the electromagnetic spectrum. Thus, the UE's communication over the second frequency range may be vulnerable to substantial propagation loss and signal loss when the UE does not have a clear line of sight (LOS) to the base station(s). The UE's investment of power to search and measure frequencies in the second frequency range may be wasted if channel conditions are not favorable on the second frequency range. Thus, there exists need for mechanisms capable of controlling processes such as search and/or measurement on frequencies in the second frequency range.

### SUMMARY

A user equipment (UE) device may need to search (or scan) and measure a frequency. The term “measurement” refers to the measurement of the energy of a cell in one or more frequency ranges. The term “search” refers to the frequency scanning performed by the UE device when it is not camped to a network, or the frequency scanning performed during a measurement gap instance. Scanning may be limited to scanning a particular frequency or the group of frequencies that the UE device supports. (Different makes and models of UE device may support different groups of frequencies.)

In one set of embodiments, a UE device may be configured to support communication over a first frequency range and a second frequency range with the second frequency range being higher in frequency than the first frequency range. For example, the first frequency range may be the frequency range defined by 3GPP Long Term Evolution or the FR1 frequency range defined by 5G New Radio (NR). The second frequency range may be the FR2 frequency range defined by 5G NR. The UE device may determine an extent of preference of the second frequency range over the first frequency range, e.g., based on one or more of the following: measurements from one or more sensors; measurements from a physical communication channel; a learned relationship between previous location-time conditions and communication performance on the second frequency range. The UE device may control search activity and/or measurement activity on the second frequency range based on the extent of preference, e.g., by controlling rates of repetition of search and measurement on the second frequency range, or by adding a measurement bias to a measurement reporting threshold, or by adding a delay to a measurement reporting time for an FR2 measurement, or by disabling search and measurement on the second frequency range.

In some embodiments, the extent of preference may be determined based on one or more of the following: extent of UE motion; extent of Doppler shift relative to a base station; condition of the UE's battery; the rate of handovers relating to the second frequency range; weather conditions in the geographical area of the UE device; whether the UE is in an active voice call (e.g., a Voice over NR call); whether the UE is in an idle state or a connected state; average transmit power over recent measurement samples; indoor/outdoor status of the UE device; whether or not the UE device is located inside an automobile.

The present patent discloses various mechanisms for using sensing assisted information to derive extent of FR2 preference. The extent of preference may be used to adjust the (inter-frequency/inter-RAT) search and measurement priority, e.g., for FR2 system selection in the context of 5G NR Standalone (SA) or Non-Standalone (NSA). (RAT is an acronym for Radio Access Technology.) These mechanisms may conserve the UE's battery power and improve link reliability. When FR2 is not preferred, the UE device may slow or even stop search and/or measurement activity on FR2, e.g., to save power. With the help of input from one or more sensors (such as motion sensor, Doppler shift sensor, etc.), FR2 can be de-prioritized for better link reliability and performance improvement. The UE device may avoid FR2 selection-failure when FR2 quality is unstable or poor.

### BRIEF DESCRIPTION OF THE DRAWINGS

A better understanding of the present subject matter can be obtained when the following detailed description of the preferred embodiment is considered in conjunction with the following drawings.

FIGS. 1-2 illustrate examples of wireless communication systems, according to some embodiments.

FIG. 3 illustrates an example of a base station in communication with a user equipment device, according to some embodiments.

FIG. 4 illustrates an example of a block diagram of a user equipment device, according to some embodiments.

FIG. 5 illustrates an example of a block diagram of a base station, according to some embodiments.

FIG. 6 illustrates an example of a user equipment device 600, according to some embodiments.

FIG. 7 illustrates an example of a base station 700, according to some embodiments. The base station 700 may be used to communicate with user equipment 600 of FIG. 6.

FIG. 8 illustrates an area of coverage on the FR2 frequency range of 5G NR, according to some embodiments.

FIG. 9 illustrates three different versions of a mechanism for determining an extent of preference of a higher frequency range over a lower frequency range, according to some embodiments.

FIG. 10 illustrates an example of a non-standalone (NSA) deployment of 5G NR, according to some embodiments. (gNB is the base station of 5G NR. eNB is the base station of 3GPP Long Term Evolution.)

FIG. 11 illustrates an example of a standalone (SA) deployment of 5G NR, according to some embodiments.

FIG. 12 describes two different states of preference of a second (higher) frequency range relative a first (lower) frequency range, according to some embodiments.

FIG. 13 illustrates possible states of a preference indicator and corresponding values of search period and measurement period, according to some embodiments.

FIGS. 14 and 15 illustrate an example of an algorithm for controlling search and measurement processes based on inputs such as battery condition, average transmit power and state of connection with network, according to some embodiments.

FIG. 16 illustrates an example of a method for structuring measurement gap information to be transmitted to a user equipment device, where the measurement map information defines a measurement gap for one or more frequency ranges supported by the UE, according to some embodiments.

FIG. 17 illustrates an example of a data structure for configuration information to be transmitted to a user equipment device, enabling the network to configure a measurement gap for one or more frequency ranges supported by the UE, according to some embodiments.

FIG. 18 illustrates an example of an algorithm that controls measurements on an FR2 frequency range of 5G NR based on one or more conditions such as UE mobility and measured signal strength, according to some embodiments.

FIG. 19 illustrates an example of a method for determining an extent of preference for an FR2 frequency range of 5G NR, and employing the determined preference extent to control search and/or measurement processes on the FR2 frequency range, according to some embodiments.

FIG. 20 illustrates an example of possible realizations for the inputs to the method of FIG. 19, according to some embodiments.

FIG. 21 illustrates an example of three versions of a method for determining extent of preference for a high frequency range (that includes one or more millimeter wave bands), according to some embodiments.

FIG. 22 illustrates an example of an algorithm for determining extent of preference for a high frequency range (that includes one or more millimeter wave bands), based on mobility information and Doppler shift, according to some embodiments.

FIG. 23 illustrates an example of a method for controlling search activity and/or measurement activity on a high frequency range (that includes one or more millimeter wave bands), according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

The following acronyms are used in this disclosure.

3GPP: Third Generation Partnership Project

3GPP2: Third Generation Partnership Project 2

5G NR: 5^{th} Generation New Radio

BW: Bandwidth

BWP: Bandwidth Part

CA: Carrier Aggregation

CQI: Channel Quality Indictor

CSI: Channel State Information

DC: Dual Connectivity

DCI: Downlink Control Information

DL: Downlink

eNB (or eNodeB): Evolved Node B, i.e., the base station of 3GPP LTE

eUICC: embedded UICC

gNB (or gNodeB): next Generation NodeB, i.e., the base station of 5G NR

GSM: Global System for Mobile Communications

HARQ: Hybrid ARQ

LTE: Long Term Evolution

LTE-A: LTE-Advanced

MAC: Medium Access Control

MAC-CE: MAC Control Element

NR: New Radio

NR-DC: NR Dual Connectivity

NW: Network

PDCCH: Physical Downlink Control Channel

PDSCH: Physical Downlink Shared Channel

PUCCH: Physical Uplink Control Channel

PUSCH: Physical Uplink Shared Channel

RACH: Random Access Channel

RAT: Radio Access Technology

RLC: Radio Link Control

RLM: Radio Link Monitoring

RRC: Radio Resource Control

RRM: Radio Resource Management

RS: Reference Signal

SR: Scheduling Request

SRS: Sounding Reference Signal

SSB: Synchronization Signal Block

UCI: Uplink Control Information

UE: User Equipment

UL: Uplink

UMTS: Universal Mobile Telecommunications System

### Terms

The following is a glossary of terms used in this disclosure:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to any of various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

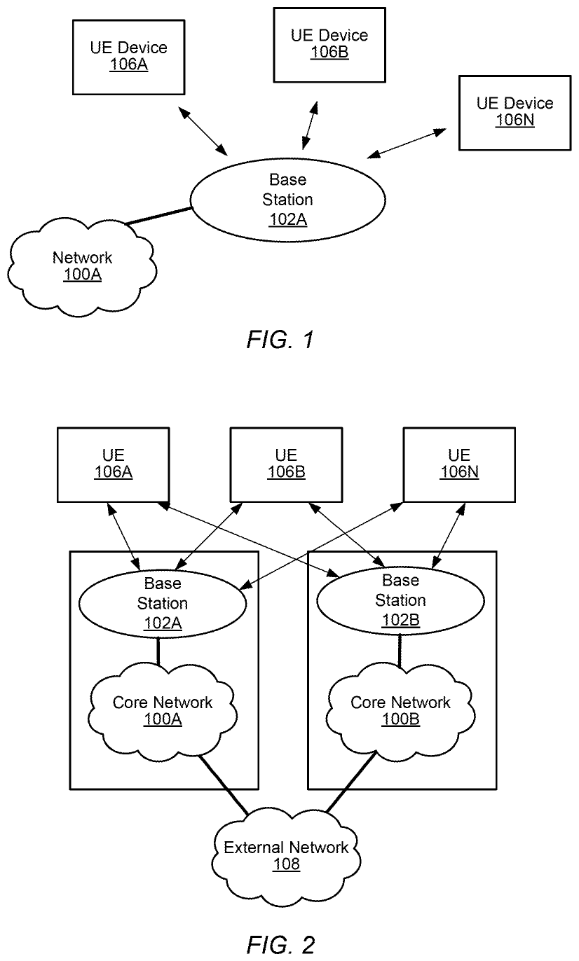

### FIGS. 1-3: Communication System

FIGS. 1 and 2 illustrate exemplary (and simplified) wireless communication systems. It is noted that the systems of FIGS. 1 and 2 are merely examples of certain possible systems, and various embodiments may be implemented in any of various ways, as desired.

The wireless communication system of FIG. 1 includes a base station 102A which communicates over a transmission medium with one or more user equipment (UE) devices 106A, 106B, etc., through 106N. Each of the user equipment devices may be referred to herein as “user equipment” (UE). In the wireless communication system of FIG. 2, in addition to the base station 102A, base station 102B also communicates (e.g., simultaneously or concurrently) over a transmission medium with the UE devices 106A, 106B, etc., through 106N.

The base stations 102A and 102B may be base transceiver stations (BTSs) or cell sites, and may include hardware that enables wireless communication with the user devices 106A through 106N. Each base station 102 may also be equipped to communicate with a core network 100 (e.g., base station 102A may be coupled to core network 100A, while base station 102B may be coupled to core network 100B), which may be a core network of a cellular service provider. Each core network 100 may be coupled to one or more external networks (such as external network 108), which may include the Internet, a Public Switched Telephone Network (PSTN), or any other network. Thus, the base station 102A may facilitate communication between the user devices and/or between the user devices and the network 100A; in the system of FIG. 2, the base station 102B may facilitate communication between the user devices and/or between the user devices and the network 100B.

The base stations 102A and 102B and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), 5G NR, 3GPP2 CDMA2000 (e.g., 1×RTT, 1×EV-DO, HRPD, eHRPD), Wi-Fi, WiMAX, etc.

For example, base station 102A and core network 100A may operate according to a first cellular communication standard (e.g., 5G NR) while base station 102B and core network 100B operate according to a second (e.g., different) cellular communication standard (e.g., LTE, GSM, UMTS, and/or one or more CDMA2000 cellular communication standards). The two networks may be controlled by the same network operator (e.g., cellular service provider or “carrier”), or by different network operators. In addition, the two networks may be operated independently of one another (e.g., if they operate according to different cellular communication standards), or may be operated in a somewhat coupled or tightly coupled manner.

Note also that while two different networks may be used to support two different cellular communication technologies, such as illustrated in the network configuration shown in FIG. 2, other network configurations implementing multiple cellular communication technologies are also possible. As one example, base stations 102A and 102B might operate according to different cellular communication standards but couple to the same core network. As another example, multi-mode base stations capable of simultaneously supporting different cellular communication technologies (e.g., 5G NR, LTE, CDMA 1×RTT, GSM and UMTS, or any other combination of cellular communication technologies) might be coupled to a core network that also supports the different cellular communication technologies. Any of various other network deployment scenarios are also possible.

As a further possibility, it is also possible that base station 102A and base station 102B may operate according to the same wireless communication technology (or an overlapping set of wireless communication technologies). For example, base station 102A and core network 100A may be operated by one cellular service provider independently of base station 102B and core network 100B, which may be operated by a different (e.g., competing) cellular service provider. Thus, in this case, despite utilizing similar and possibly compatible cellular communication technologies, the UE devices 106A-106N might communicate with the base stations 102A-102B independently, possibly by utilizing separate subscriber identities to communicate with different carriers' networks.

A UE 106 may be capable of communicating using multiple wireless communication standards. For example, a UE 106 might be configured to communicate using either or both of a 3GPP cellular communication standard (such as 5G NR or LTE) or a 3GPP2 cellular communication standard (such as a cellular communication standard in the CDMA2000 family of cellular communication standards). As another example, a UE 106 might be configured to communicate using different 3GPP cellular communication standards (such as two or more of GSM, UMTS, LTE, LTE-A and 5G NR). Thus, as noted above, a UE 106 might be configured to communicate with base station 102A (and/or other base stations) according to a first cellular communication standard (e.g., 5G NR) and might also be configured to communicate with base station 102B (and/or other base stations) according to a second cellular communication standard (e.g., LTE, one or more CDMA2000 cellular communication standards, UMTS, GSM, etc.).

Base stations 102A and 102B and other base stations operating according to the same or different cellular communication standards may thus be provided as one or more networks of cells, which may provide continuous or nearly continuous overlapping service to UEs 106A-106N and similar devices over a wide geographic area via one or more cellular communication standards.

A UE 106 might also or alternatively be configured to communicate using WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

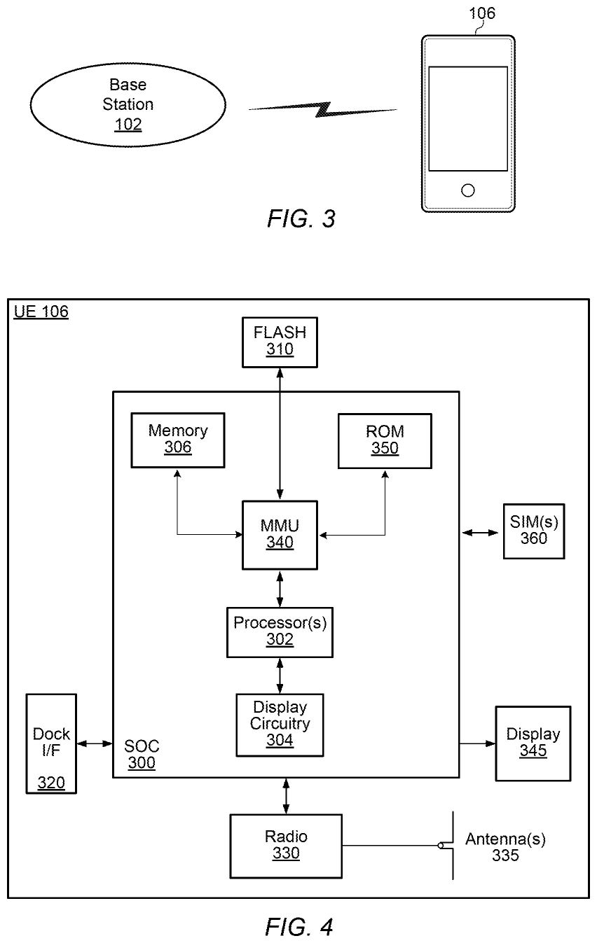

FIG. 3 illustrates user equipment 106 (e.g., one of the devices 106A through 106N) in communication with a base station 102 (e.g., one of the base stations 102A or 102B). The UE 106 may be a device with wireless network connectivity such as a mobile phone, a hand-held device, a computer or a tablet, a wearable device or virtually any type of wireless device.

The UE may include a processor that is configured to execute program instructions stored in memory. The UE may perform any of the method embodiments described herein by executing such stored instructions. Alternatively, or in addition, the UE may include a programmable hardware element such as an FPGA (field-programmable gate array) that is configured to perform any of the method embodiments described herein, or any portion of any of the method embodiments described herein.

The UE 106 may be configured to communicate using any of multiple wireless communication protocols. For example, the UE 106 may be configured to communicate using two or more of GSM, UMTS (W-CDMA, TD-SCDMA, etc.), CDMA2000 (1×RTT, 1×EV-DO, HRPD, eHRPD, etc.), LTE, LTE-A, 5G NR, WLAN, or GNSS. Other combinations of wireless communication standards are also possible.

The UE 106 may include one or more antennas for communicating using one or more wireless communication protocols. Within the UE 106, one or more parts of a receive and/or transmit chain may be shared between multiple wireless communication standards; for example, the UE 106 might be configured to communicate using either (or both) of GSM or LTE using a single shared radio. The shared radio may include a single antenna, or may include multiple antennas (e.g., for MIMO or beamforming) for performing wireless communications. MIMO is an acronym for Multi-Input Multiple-Output.

### FIG. 4—Example of Block Diagram of a UE

FIG. 4 illustrates an example of a block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 345. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 345. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including Flash memory 310), a connector interface 320 (e.g., for coupling to a computer system, dock, charging station, etc.), the display 345, and radio 330.

The radio 330 may include one or more RF chains. Each RF chain may include a transmit chain, a receive chain, or both. For example, radio 330 may include two RF chains to support dual connectivity with two base stations (or two cells). The radio may be configured to support wireless communication according to one or more wireless communication standards, e.g., one or more of GSM, UMTS, LTE, LTE-A, 5G NR, WCDMA, CDMA2000, Bluetooth, Wi-Fi, GPS, etc.

The radio 330 couples to antenna subsystem 335, which includes one or more antennas. For example, the antenna subsystem 335 may include a plurality of antennas to support applications such as dual connectivity or MIMO or beamforming. The antenna subsystem 335 transmits and receives radio signals to/from one or more base stations or devices through the radio propagation medium, which is typically the atmosphere.

In some embodiments, the processor(s) 302 may include a baseband processor to generate uplink baseband signals and/or to process downlink baseband signals. The processor(s) 302 may be configured to perform data processing according to one or more wireless telecommunication standards, e.g., one or more of GSM, UMTS, LTE, LTE-A, 5G NR, WCDMA, CDMA2000, Bluetooth, Wi-Fi, GPS, etc.

The UE 106 may also include one or more user interface elements. The user interface elements may include any of various elements, such as display 345 (which may be a touchscreen display), a keyboard (which may be a discrete keyboard or may be implemented as part of a touchscreen display), a mouse, a microphone and/or speakers, one or more cameras, one or more sensors, one or more buttons, sliders, and/or dials, and/or any of various other elements capable of providing information to a user and/or receiving/interpreting user input.

As shown, the UE 106 may also include one or more subscriber identity modules (SIMs) 360. Each of the one or more SIMs may be implemented as an embedded SIM (eSIM), in which case the SIM may be implemented in device hardware and/or software. For example, in some embodiments, the UE 106 may include an embedded UICC (eUICC), e.g., a device which is built into the UE 106 and is not removable. The eUICC may be programmable, such that one or more eSIMs may be implemented on the eUICC. In other embodiments, the eSIM may be installed in UE 106 software, e.g., as program instructions stored on a memory medium (such as memory 306 or Flash 310) executing on a processor (such as processor 302) in the UE 106. As one example, a SIM 360 may be an application which executes on a Universal Integrated Circuit Card (UICC). Alternatively, or in addition, one or more of the SIMs 360 may be implemented as removeable SIM cards.

The processor 302 of the UE device 106 may be configured to implement part or all of the methods described herein, e.g., by executing program instructions stored on a memory medium (e.g., a non-transitory computer-readable memory medium). In other embodiments, processor 302 may be configured as or include: a programmable hardware element, such as an FPGA (Field Programmable Gate Array); or an ASIC (Application Specific Integrated Circuit); or a combination thereof.

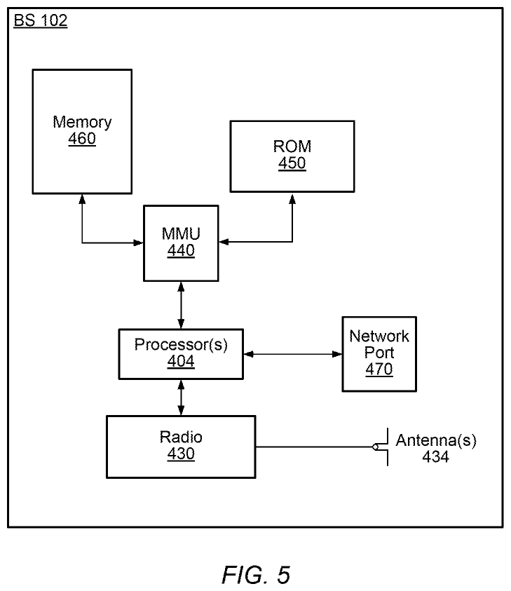

### FIG. 5—Example of a Base Station

FIG. 5 illustrates a block diagram of a base station 102. It is noted that the base station of FIG. 5 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory ROM 450) or to other circuits or devices.

The base station 102 may include at least one network port 470. The network port 470 may be configured to couple to a telephone network and provide access (for a plurality of devices, such as UE devices 106) to the telephone network, as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include a radio 430 having one or more RF chains. Each RF chain may include a transmit chain, a receive chain, or both. (For example, the base station 102 may include at least one RF chain per sector or cell.) The radio 430 couples to antenna subsystem 434, which includes one or more antennas. Multiple antennas would be needed, e.g., to support applications such as MIMO or beamforming. The antenna subsystem 434 transmits and receives radio signals to/from UEs through the radio propagation medium (typically the atmosphere).

In some embodiments, the processor(s) 404 may include a baseband processor to generate downlink baseband signals and/or to process uplink baseband signals. The baseband processor 430 may be configured to operate according to one or more wireless telecommunication standards, including, but not limited to, GSM, LTE, LTE-A, 5G NR, WCDMA, CDMA2000, etc.

The processor(s) 404 of the base station 102 may be configured to implement part or all of the methods described herein, e.g., by executing program instructions stored on a memory medium (e.g., a non-transitory computer-readable memory medium). In some embodiments, the processor(s) 404 may include: a programmable hardware element, such as an FPGA (Field Programmable Gate Array); or an ASIC (Application Specific Integrated Circuit); or a combination thereof.

### Wireless User Equipment Device 600

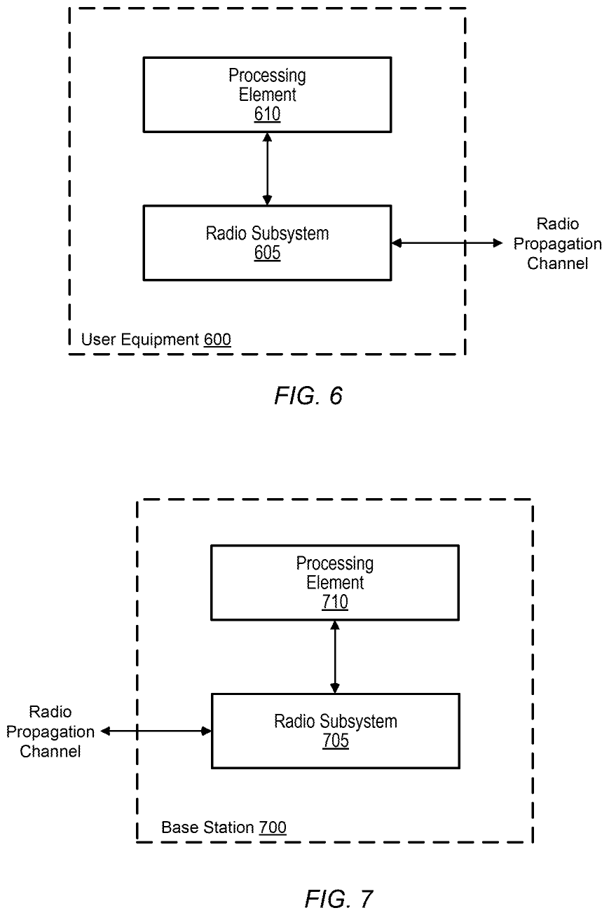

In some embodiments, a wireless user equipment (UE) device 600 may be configured as shown in FIG. 6. UE device 600 may include: a radio subsystem 605 for performing wireless communication; and a processing element 610 operatively coupled to the radio subsystem. (UE device 600 may also include any subset of the UE features described above, e.g., in connection with FIGS. 1-4.)

The radio subsystem 605 may include one or more RF chains, e.g., as variously described above. Each RF chain may be configured to receive signals from the radio propagation channel and/or transmit signals onto the radio propagation channel. Thus, each RF chain may include a transmit chain and/or a receive chain. The radio subsystem 605 may be coupled to one or more antennas (or arrays of antennas) to facilitate signal transmission and reception. Each RF chain (or, some of the RF chains) may be tunable to a desired frequency, thus allowing the RF chain to receive or transmit at different frequencies at different times.

The radio subsystem 605 may be coupled to one or more antenna panels (or antenna arrays), e.g., to support beamforming of received downlink signals and/or transmitted uplink signals.

The processing element 610 may be coupled to the radio subsystem, and may be configured as variously described above. (For example, the processing element may be realized by processor(s) 302.) The processing element may be configured to control the state of each RF chain in the radio subsystem.

In some embodiments, the processing element may include one or more baseband processors to (a) generate baseband signals to be transmitted by the radio subsystem and/or (b) process baseband signals provided by the radio subsystem.

In various embodiments described herein, when a processing element of a wireless user equipment device is said to transmit and/or receive information to/from a wireless base station (or Transmission-Reception Point), it should be understood that such transmission and/or reception occurs by the agency of a radio subsystem such as radio subsystem 605. Transmission may involve the submission of signals and/or data to the radio subsystem, and reception may involve the action of receiving signals and/or data from the radio subsystem.

In some embodiments, the UE device 600 may include beamforming circuity. The beamforming circuity may be configured to receive downlink signals from respective antennas of an antenna array of the UE device, and to apply receive beamforming to the downlink signals. For example, the beamforming circuity may apply weights (e.g., complex weights) to the respective downlink signals, and then combine the weighted downlink signals to obtain a beam signal, where the weights define a reception beam. The beamforming circuity may also be configured to apply weights to respective copies of an uplink signal, and to transmit the weighted uplink signals via respective antennas of the antenna array of the UE device, wherein the weights define a transmission beam. In some embodiments, beamforming may be applied to transmissions of the Physical Uplink Control Channel (PUCCH) and the Physical Uplink Shared Channel (PUSCH).

In some embodiments, the beamforming circuity may be implemented by (or included in) the processing element 610. In other embodiments, beamforming circuity may be included in the radio subsystem 605.

In some embodiments, the UE device 600 (e.g., the processing element 610) may be configured to receive configuration messages from the base station. A configuration message may direct the UE device to set parameters to control behavior of the UE device, e.g., to control search, measurement and reporting of measurements to the base station, etc. Configuration messages may request any of different types of reporting, e.g., periodic, semi-static, aperiodic, etc. Configuration messages may indicate any of different types of measurements, e.g., signal to interference-and-noise ratio (SINR), any of various types of channel quality information (CQI), reference signal receiver power (RSRP), etc.

In some embodiments, the radio subsystem 605 may be configured to transmit and receive in one or more frequency ranges. For example, frequency ranges may include a lower frequency range and a higher frequency range. The higher frequency range may include one or more of those frequency bands in the millimeter wave regime of the electromagnetic spectrum, where the effects of propagation loss and signal blockage may be significant.

In some embodiments, the UE 600 (e.g., the processing element) may support carrier aggregation. Carrier aggregation (CA) involves the concatenation of a plurality of component carriers (CCs), which increases the bandwidth and data rate to and/or from the UE 600. When carrier aggregation is employed, the timing of frames may be aligned across cells involved in the aggregation. Different embodiments may support different maximum bandwidths and numbers of component carriers. In some embodiments, the UE 600 may concatenate component carriers from two or more base stations, of the same or different radio access technology. (For example, in some embodiments, the UE may perform carrier aggregation with an eNB of 3GG LTE and a gNB of 5G NR.) In some embodiments, the UE 600 may support both contiguous carriers and non-contiguous carriers.

In some embodiments, in a dual connectivity mode of operation, the processing element may direct a first RF chain to communicate with a first base station using a first radio access technology and direct a second RF chain to communicate with a second base station using a second radio access technology. For example, the first RF chain may communicate with an LTE eNB, and the second RF chain may communicate with a gNB of 5G New Radio (NR). The link with the LTE eNB may be referred to as the LTE branch. The link with the gNB may be referred to as the NR branch. In some embodiments, the processing element may include a first subcircuit for baseband processing with respect to the LTE branch and a second subcircuit for baseband processing with respect to the NR branch.

The processing element 610 may be further configured as variously described in the sections below.

### Wireless Base Station 700

In some embodiments, a wireless base station 700 of a wireless network (not shown) may be configured as shown in FIG. 7. The wireless base station may include: a radio subsystem 705 for performing wireless communication over a radio propagation channel; and a processing element 710 operatively coupled to the radio subsystem. (The wireless base station may also include any subset of the base station features described above, e.g., the features described above in connection with FIG. 5.)

The radio subsystem 710 may include one or more RF chains. Each RF chain may be tunable to a desired frequency, thus allowing the RF chain to receive or transmit at different frequencies at different times.

The processing element 710 may be realized as variously described above. For example, in one embodiment, processing element 710 may be realized by processor(s) 404. In some embodiments, the processing element may include one or more baseband processors to: (a) generate baseband signals to be transmitted by the radio subsystem, and/or, (b) process baseband signals provided by the radio subsystem.

In some embodiments, the base station 700 may include beamforming circuity. The beamforming circuity may be configured to receive uplink signals from respective antennas of an antenna array of the base station, and to apply receive beamforming to the uplink signals. For example, the beamforming circuity may apply weights (e.g., complex weights) to the respective uplink signals, and then combine the weighted uplink signals to obtain a beam signal, where the weights define a reception beam. Different reception beams may be used to receive from different UE devices. The beamforming circuity may also be configured to apply weights to respective copies of a downlink signal, and to transmit the weighted downlink signals via respective antennas of the antenna array of the base station, where the weights define a transmission beam. Different transmission beams may be used to transmit to different UE devices.

In some embodiments, the beamforming circuity may be implemented by (or included in) the processing element 710. In other embodiments, beamforming circuity may be included in the radio subsystem 705.

The processing element 710 may be configured to perform any of the base station method embodiments described herein.

### Sensing-Assisted Search/Measurement Priority for FR2 System Selection

The 5G New Radio (NR) framework supports both an FR1 frequency range and an FR2 frequency range as well as legacy LTE via EN-DC or carrier aggregation. (LTE is an acronym for Long Term Evolution. EN-DC is an acronym for E-UTRAN New Radio-Dual Connectivity. E-UTRAN is an acronym for Evolved-UMTS Terrestrial Radio Access Network. UMTS is an acronym for Universal Mobile Telecommunications Service.)

Because FR2 includes one or more bands in the millimeter wave regime, transmissions on FR2 may enjoy wider bandwidth and larger beamforming gain, and thus, FR2 is targeted for high throughput applications, but with stability and power concerns. Typical applications for FR2 include video streaming, video gaming, traffic off-loading, etc. Power consumption is a concern due to complex beamforming architecture in FR2. Stability of FR2 communication is also a concern due to various blockage effects.

Consider a network deployment with both sub-6 GHz (4G LTE, or 5G NR FR1) and FR2 millimeter wave (mmWave). It is natural to ask, is FR2 mmWave communication currently preferred over sub-6 GHz communication (as in LTE or NR FR1)?

As an example, FR2 mmWave may be preferred for applications requiring high throughput, and/or, for stationary or low mobility channel environments.

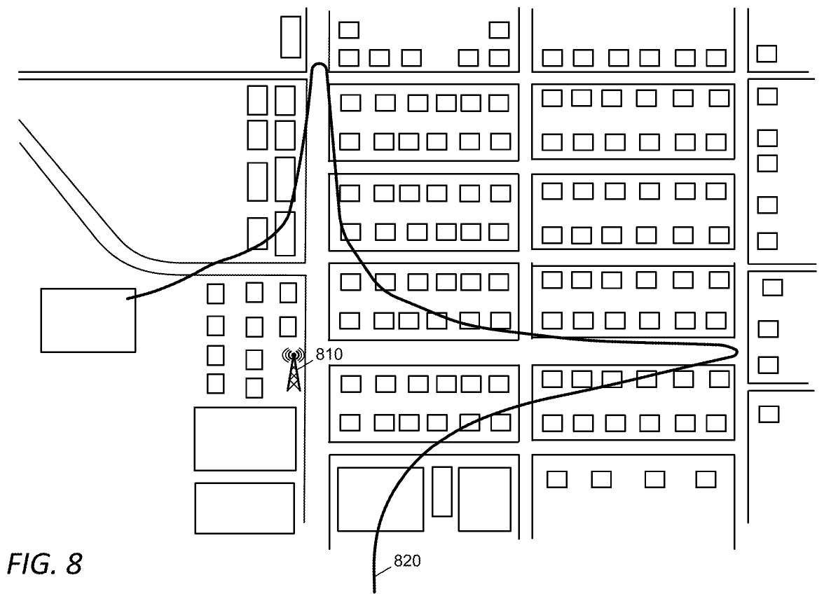

FIG. 8 illustrates a coverage area for a base station 810 (e.g., a gNB of 5G NR) operating on FR2 in a mostly residential area. The boundary 820 of the coverage area extends farther along paths that are unobstructed than along paths that are obstructed by objects such as buildings, trees, vehicles, etc. For example, under certain circumstances, a line of sight distance (LOS) from the base station to the boundary may be approximately three times a non-LOS distance to the boundary.

From the UE's point of view, FR2 preference (i.e., extent of preference for FR2 over FR1 or LTE frequency range) can be derived from sensing information since it may be highly correlated with various types of sensing information (mobility, location, application type, etc.).

The FR2 stability issue is caused by blockage effects that can be sensed via one or more UE sensors.

The present patent presents multiple ways of utilizing sensing information to assist FR2 preference derivation. The FR2 preference may be used to adjust the search and/or measurement priority for FR2 system selection.

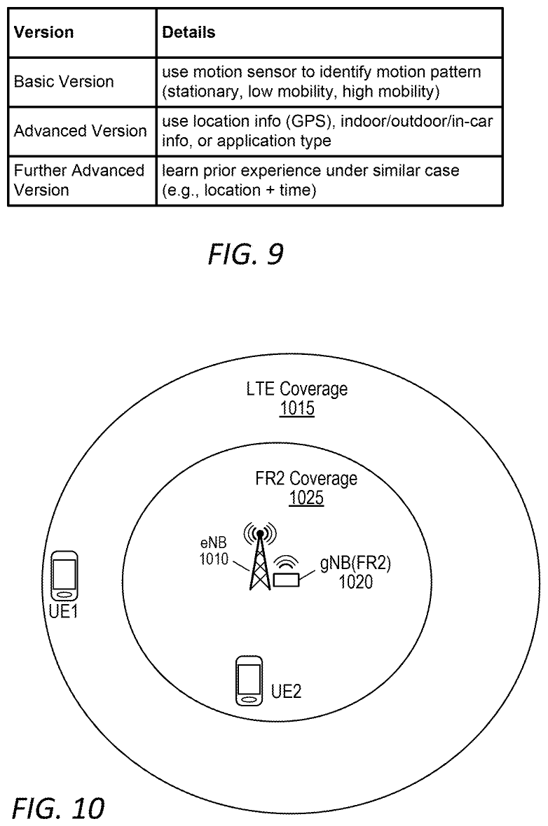

FIG. 9 illustrates three versions of a mechanism for determining an extent of FR2 preferences. In a basic version, the UE may employ a motion sensor (that senses translational and/or rotational motion of the UE) to identify the present motion pattern of the UE, such as among a set of possibilities, e.g., possibilities such as stationary, low mobility, high mobility. In an advanced version, the UE may employ one or more of the following: location information (such as GPS location); an indicator of type of environment the UE is located in: indoors, out of doors, in car, etc. In a further advanced version, the UE may learn from prior experiences of FR2 performance as a function of location and/or time. The patterns acquired from such learning may be used to control present determinations of FR2 preference as a function of location and/or time.

### FR2 System Selection

To illustrate FR2 system selection, one might consider two typical FR2 deployment types: colocated and non-colocated eNB and gNB. (eNB is the base station of 3GPP Long Term Evolution. gNB is the base station of 5G NR.)

FIG. 10 illustrates the case of a colocated gNB and eNB, e.g., the case of a non-standalone (NSA) deployment of 5G NR. In other words, the eNB 1010 and gNB 1020 transmit and receive from approximately the same location. The eNB operates in a an LTE frequency range FR_{LTE}, and the gNB operates in a frequency range FR2 that is higher in the frequency spectrum than FR_{LTE}. The eNB has a coverage area 1015, and the gNB has a coverage area 1025. The coverage areas may be populated with UEs, of which UE1 and UE2 are meant to be representatives.

In the NSA type FR2 deployment (with LTE as an anchor carrier), the following algorithm may be employed to perform FR2 system selection. The UE may first connect to the LTE carrier via eNB 1010. The network may then configure the UE with an FR2 frequency channel. The UE may then periodically search the FR2 frequency channel. For a detected FR2 cell (e.g., a cell hosted by gNB 1020), the UE may periodically measures its signal strength, e.g., RSRP strength. (RSRP is an acronym for Reference Signal Received Power.) When the condition for measurement reporting is met, the UE may send B1/B2 measurement report to network, e.g., as defined in 3GPP TS 36.331, Sections 5.5.4.7 & 5.5.4.8, v.15.7.0, or 3GPP TS 38.331, Sections 5.5.4.8 & 5.5.4.9, v.15.7.0. (TS is an acronym for Technical Specification.) Based on the measurement report, the network may configure UE to add an FR2 carrier (e.g., as a secondary carrier).

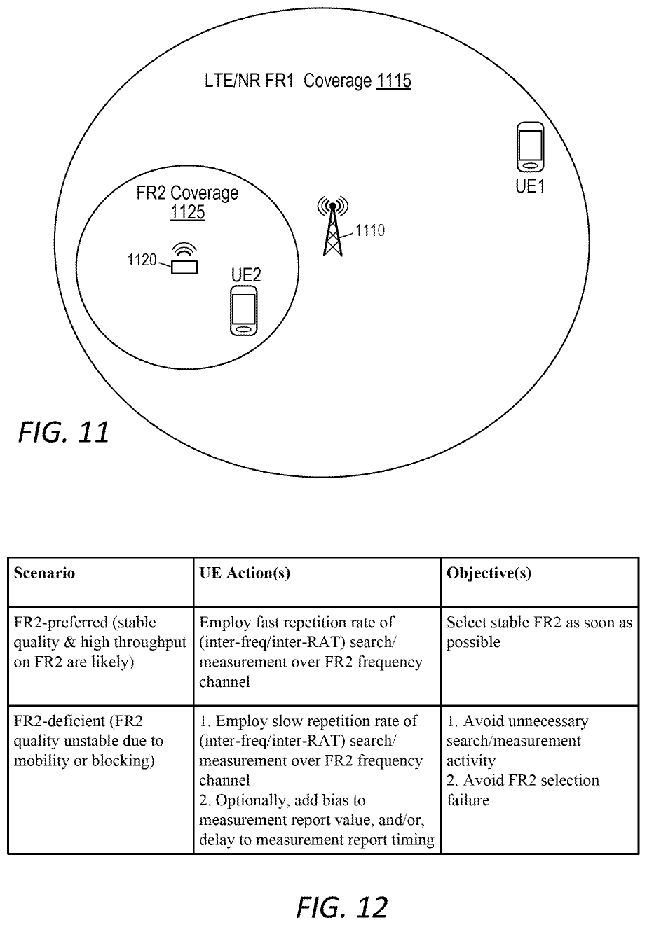

FIG. 11 illustrates a non-colocated deployment, e.g., according to a standalone (SA) deployment of 5G NR. A first base station 1010 may be configured for LTE operation on an LTE frequency range (FR_{LTE}) or for 5G NR operation on FR1. A second base station 1020 may be configured for 5G NR operation on FR2, which is higher the frequency spectrum than FR_{LTE} and FR1. The first base station 1110 has a coverage area 1115 (the “LTE/NR FR1 coverage area”), and the second base station 1120 has a coverage area 1125 (the “FR2 coverage area”).

In the non-colocated deployment, the UE may first connect to LTE or NR FR1 carrier via base station 1110. The network may then configure the UE to monitor an FR2 frequency channel. The UE may employ inter-frequency/inter-RAT search and measurement to detect an FR2 cell. When the condition for measurement reporting is met, the UE may send a measurement report to the base station 1110 (e.g., gNB). Based on the measurement report, the network may trigger a cell-addition or hand-over process to select the FR2 cell as part of UE's carrier set. (Note that typically there may be no direct correlation between LTE and FR2 cell measurement results.)

### Search/Measurement Activities During FR2 System Selection

FR2 system selection often involves inter-frequency/inter-RAT search and measurement activities (at FR2 frequency channel). The scheduling of such search and measurement events may be controlled by UE itself. From the UE's point-of-view, such UE control may be based on FR2-preference information.

FIG. 12 illustrates two states of preference for FR2 (relative to FR1 or FR_{LTE}), corresponding UE actions, and corresponding objectives. In an FR2-preferred state, which represents an expectation of stable quality and high throughput on FR2, the UE may employ a fast repetition rate of (inter-frequency/inter-RAT) search/measurement over an FR2 frequency channel, with the objective being to select a stable FR2 frequency channel promptly, e.g., as soon as possible. (RAT is an acronym for Radio Access Technology.)

In an FR2-deficient state, which represents an expectation of unstable quality on FR2 (due to mobility and/or blocking), the UE may: employ a slow repetition rate of (inter-frequency/inter-RAT) search/measurement over FR2 frequency channel; and optionally, add bias to measurement report value for an FR2 measurement, and/or, add delay to measurement report timing. The objective of such actions may be to avoid unnecessary search/measurement activity, and avoid FR2 selection failure.

### Search/Measurement Priority (for FR2 System Selection)

In some embodiments, search/measurement priority (for FR2 system selection) may be expressed in terms of actions such as one or more of the following. The UE may adjust the periodicity of search and/or measurement operations. The UE may add an artificial bias to measurement report value (making it easier or more difficult to trigger transmission of a measurement report), and/or, add an artificial delay in measurement report timing.

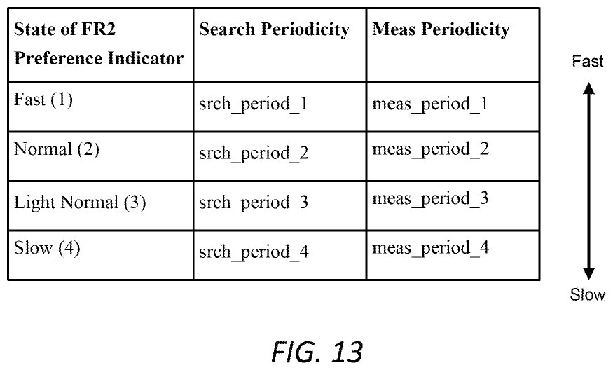

Taking search/measurement periodicity as an example, the UE may have a plurality of periodicity options with fast/slow rates of repetition of search/measurement. Based on FR2 preference, the UE may select a periodicities for search activity and measurement activity during FR2 system selection. In one embodiment, as shown in FIG. 13, an FR2 preference indicator may have four states: Fast, Normal, Light Normal and Slow. Each of the states corresponds to a respective value (srch_period_k) of search period and a respective value (meas_period_k) of measurement period, with

srch_period_k<srch_period_(k+1)

meas_period_k<meas_period_(k+1).

In the others, the value of the search period and the value of the measurement period increase as the states of FR2 preference proceed from Fast to Slow.
5G NR Search/Measurement Optimizations with Sensor Inputs

In some embodiments, 5G NR search and measurement processes may be optimized based on input from one or more sensors of the UE. For example, the UE may adapt the process of FR2 measurement based on condition of the UE's battery.

In some embodiments, FR2 measurement adaptation may involve the following algorithm, which is referred to herein as algorithm LP1. If the UE is camped to 5G-NR FR1, and the UE is in lower power mode and/or the UE battery has less than BP_{LOW} power remaining, the UE may determine if the UE is in 5GMM-IDLE mode. (The threshold value BP_{LOW} make take any of a wide variety of values. For example, in one embodiment, BP_{LOW} may equal 18%, or 20%, or 22%. 5GMM is an acronym for 5G Mobility Management.)

If the UE is in the 5GMM-IDLE mode, the UE may perform the following operations to conserve power. The UE may disable all (or alternatively, some) FR2 measurements in the 5GMM-IDLE mode; send a Tracking Area Update (TAU) to network with the following information element enabled: “NG-RAN radio capability update needed”. The network may then request for UE capability information. In response to this request, the UE may send an updated UE capability with FR2 disabled and 4×4 MIMO support in FR1 disabled.

If the UE is not in the 5GMM-IDLE mode, the UE may perform the following operations to conserve power. The UE may avoid sending FR2 measurements in a measurement report; locally release the RRC connection; and transition to the 5GMM-IDLE mode. (RRC is an acronym for Radio Resource Protocol.) The UE may then disable all (or alternatively, a subset of) FR2 measurements in the 5GMM IDLE mode; and send a Tracking Area Update to network with the following information element enabled: “NG-RAN radio capability update needed”. The network may then request for UE capability information. In response to the request, the UE may send updated UE capability with FR2 disabled, and 4×4 MIMO support in FR1 disabled.

In some embodiments, FR2 measurement adaptation may involve the following algorithm, which is referred to herein as algorithm TP. When the UE is camped to 5G-NR FR2, the UE may determine if the average transmit power over the last n measurement samples is greater than TXP₁, where n is an integer greater than one. (The measurement samples are samples of the power used by the UE to transmit data to the gNB. The threshold transmit power value TXP₁ make take any of a wide variety of values, e.g., depending on application scenario. In one embodiment, TXP₁ may equal, e.g., 22 dBm.) If so, the UE may disable the higher range of FR2 frequencies (e.g., 39 GHz and above). Furthermore, the UE may determine if the average transmit power over the last n measurement samples is greater than a maximum transmit power level (MTPL). (The MTPL is greater than the threshold TXP₁, and may be configurable by the network.) If so, the UE may disable FR2 completely and disable 4×4 MIMO capabilities in FR1.

In some embodiments, if at any time during the execution of algorithm TP the following conditions are met, the UE may perform the power conservation steps of algorithm LP1 above. The conditions may include a first condition that the low power mode is ON, and a second condition that the power remaining in the UE's battery is less than BP_{LOW}. (In some embodiments, only a subset of the conditions need to be met in order to invoke the power conservation steps.)

In some embodiments, the UE may enable FR1 and/or FR2 based on condition of the UE's battery, e.g., according to the following algorithm, which is referred to herein as algorithm HP. If the UE determines that low power mode is disabled or the UE is connected to a charger, the UE may determine if the remaining power level in the UE's battery is above BP₂. (The battery power threshold BP₂ may take any of a wide variety of values, e.g., depending on application scenario. In one embodiment, BP₂ may equal 38%, or 40%, or 42%. BP₂ is greater than BP_{LOW}.) If so, the UE may enable FR2 measurements in idle mode; disable reselections to FR2; and send a tracking area update to the network with the following IE enabled: “NG-RAN radio capability update needed”. The network may then request for UE capability information. In response to the request, the UE may send an updated UE capability, to enable 4×4 MIMO support in FR1.

Furthermore, if the remaining power level of the UE's battery is above BP₃ or the RSRP of a neighbouring FR2 cell (a cell that operates in FR2) is better than Pₘᵢₙ for at least Tₘᵢₙ units of time, the UE may send a tracking area update to network with the following IE enabled: “NG-RAN radio capability update needed”. (Battery power threshold BP₃ may take any of a wide variety of values, e.g., 60% in one embodiment. BP₃ may be greater than BP₂. The threshold Pₘᵢₙ may take any of a wide variety of values, e.g., −90 dBm in one embodiment. The time duration Tₘᵢₙ may take any of a wide variety of values, e.g., 3 minutes in one embodiment. RSRP is an acronym for Reference Signal Received Power.) The network may then request for UE capability information. In response to the request, the UE may send updated UE capability with FR2 enabled.

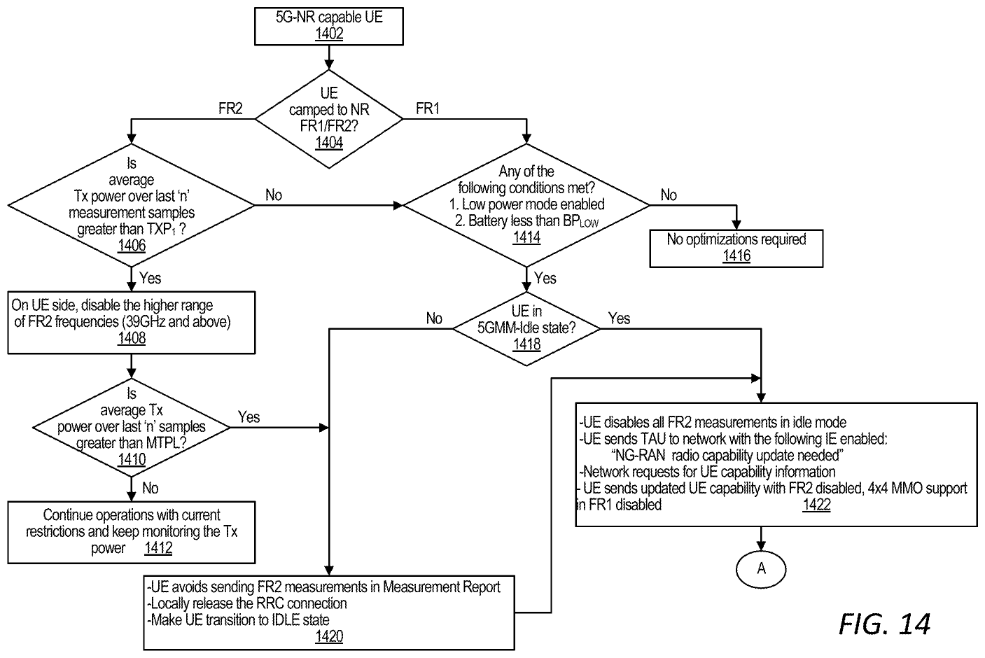

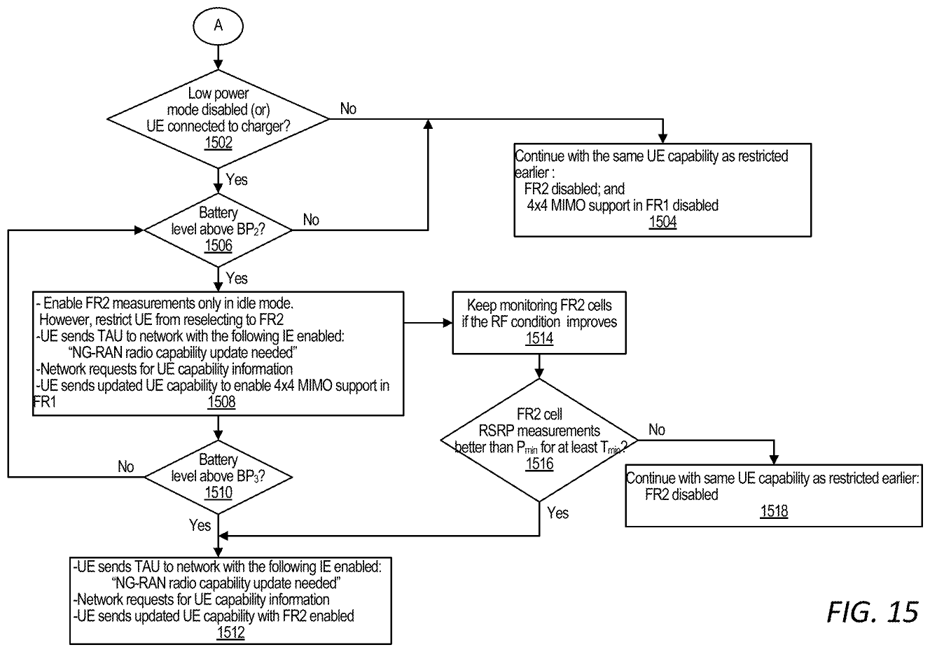

In some embodiments, a method for controlling FR2 measurements by a UE may include the operations shown in FIGS. 14 and 15, or a subset of those operations, as desired. As shown at 1402, the method may be performed by a UE that is 5G NR capable, i.e., that is equipped to operate according to the 3GPP 5G NR specifications. At 1404, the UE may determine if it is camped to NR FR1 or FR2.

In response to determining that the UE is camped to FR2, the UE may determine if the average transmit power over the last n measurement samples is greater than TXP₁, as indicated at 1406. If so, the UE may disable the higher range of FR2 frequencies (e.g., 39 GHz and above), as indicated at 1408. (If not, the UE may proceed to operation 1414, which is described below.) At 1410, the UE may determine if the average transmit power over the last n measurement samples is greater than a maximum transmit power level (MTPL), which is greater than the threshold TXP₁. If so, the UE may proceed with operation 1420. If not, the UE may continue measurement operations according to current restrictions and continue to monitor the transmit power, as indicated at 1412. At 1420, the UE may avoid sending measurement reports for FR2 measurements; locally release the RRC connection; and transition to the IDLE state.

At 1414, the UE may determine if one or more of the following conditions are met: (a) a low power mode is enabled in the UE; (b) the UE's battery power is less than BP_{LOW}. If not, no power optimizations are required, as indicated at 1416. If so, the UE may proceed with step 1418.

At 1418, the UE may determine if it is in a 5GMM Idle mode. (5GMM is an acronym for 5G Mobility Management.) If so, the UE may proceed with 1422. If not, the UE may proceed with 1420, as described above.

At 1422, the UE may disable all (or a subset of) FR2 measurements in the 5GMM Idle mode; and send a tracking area update to the network with the following IE enabled: “NG-RAN radio capability update needed”. The network may then request for UE capability information. In response to the request, the UE may send updated UE capability with FR2 disabled and 4×4 MMO support in FR1 disabled. The UE may then proceed to 1502 in FIG. 15, as indicated by the dummy node A connecting FIGS. 14 and 15.

At 1502, the UE may determine if low power mode is disabled or UE is connected to a charger? If so, the UE may proceed with 1506. If not, the UE may continue using the same UE capability as restricted earlier (i.e., FR2 disabled, and 4×4 MIMO support in FR1 disabled), as indicated at 1504.

At 1506, the UE may determine if the UE's battery level is above battery power threshold BP₂. If so, the UE may proceed to 1508. If not, the UE may continue to monitor FR2 cells if the RF condition improves, as indicated at 1514, and then proceed with 1516, described below.

At 1510, the UE may determine if the UE's battery level is above battery power threshold BP₃. If so, the UE may proceed with 1512. If not, the UE may proceed with 1506.

At 1512, the UE may send a tracking area update to the network with the following IE enabled: “NG-RAN radio capability update needed”. The network may then request for UE capability information. In response to the request, the UE may send updated UE capability with FR2 enabled.

At 1516, the UE may determine if FR2 cell RSRP measurements are greater than Pₘᵢₙ for at least Tₘᵢₙ continuous units of time. If so, the UE may proceed with 1512. If not, the UE may continue with the same UE capability as restricted earlier (i.e., with the capability that indicates FR2 as disabled.)

In some embodiments, the UE may enable FR2 measurements if any of the following conditions are satisfied: battery power level is greater than the low power threshold BP_{LOW}; UE is connected to a power source, e.g., via a charger.

### Adaptive FR2 Measurements Based on Mobility Conditions

In some embodiments, a UE device may adapt a process of FR2 measurement based on mobility conditions, e.g., based on measurements of UE motion. The millimeter wave (mmWave) frequency band suffers high attenuation when the UE is not in a Line-of-Sight (LOS). When the UE is moving across streets, the FR2 signal strength may drop, e.g., as much as 50 dBm. This variation in signal strength may be due to buildings blocking the line of sight between the gNB and UE. Thus, when UE is in a condition of mobility (e.g., medium or high mobility), the UE may disable FR2 measurements, to provide a better user experience.

In some embodiments, the UE device may adapt FR2 measurements as follows. In response to determining that the UE is in a state of medium or high mobility, the UE may disable FR2 measurements if the UE is in an in an RRC-IDLE or RRC-Inactive, and conditionally disable FR2 measurements if the UE is in an RRC Connected state. For example, in the RRC Connected state, the UE may disable FR2 measurements if the number of FR2-related handovers within X minutes is above a threshold value Nₘᵢₙ, e.g., more than 10 handovers in 1 minute in FR2. While 10 handovers and 1 minute are given as examples here, the handover number threshold Nₘᵢₙ and the time interval length X may take any of a variety of combinations of values, e.g., depending on application scenario.

In some embodiments, the UE device may adapt FR2 measurements as follows. If the UE is in an RRC-IDLE or RRC-Inactive state and stationary (based on motion sensor), the UE may determine if RF condition in FR2 is better than (or close to, or not more than 5 dB below) RF condition in FR1, and the RSRP in FR2 is greater than P_{Thresh}, the UE may prioritize FR2 measurements (over FR1 measurements), for better performance, e.g., higher bandwidth and/or data rates. (The threshold value P_{Thresh} may take any of a wide variety of values, e.g., −110 dBm in one embodiment.) The UE may prioritize FR2 measurements by decreasing the measurement period and/or the search period). If the UE is in an RRC-IDLE or RRC-Inactive state and moving, and the conditions for normal mobility reselection are satisfied, the UE may enable FR2 measurements. As per 3GPP TS 38.304, v.15.5.0, section 5.2.4.3.0, the condition corresponding to normal mobility reselections is, “If number of cell reselections during time period T_{CRmax} is less than N_{CR_M}”, where T_{CRmax}, N_{CR_H}, N_{CR_M} and T_{CRmaxHyst} are speed dependent reselection parameters broadcasted in system information for the serving cell. T_{CRmax} specifies the duration for evaluating allowed amount of cell reselection(s). N_{CR_M} specifies the maximum number of cell reselections to enter Medium-mobility state. N_{CR_H} specifies the maximum number of cell reselections to enter High-mobility state. T_{CRmaxHyst} specifies the additional time period before the UE can enter Normal-mobility state.

If the UE is in an RRC-Connected state and moving, the UE may enable FR2 measurements and monitor the number of handovers. If the number of handovers within X mins is above the threshold Nₘᵢₙ, then the UE may disable FR2 measurements.

### Adaptive FR2 Measurements During Measurement Gap

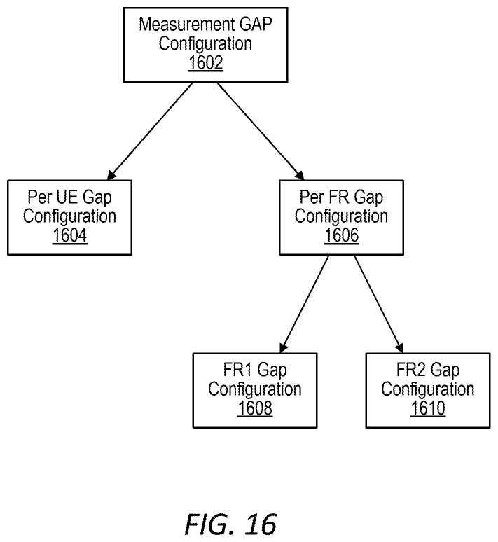

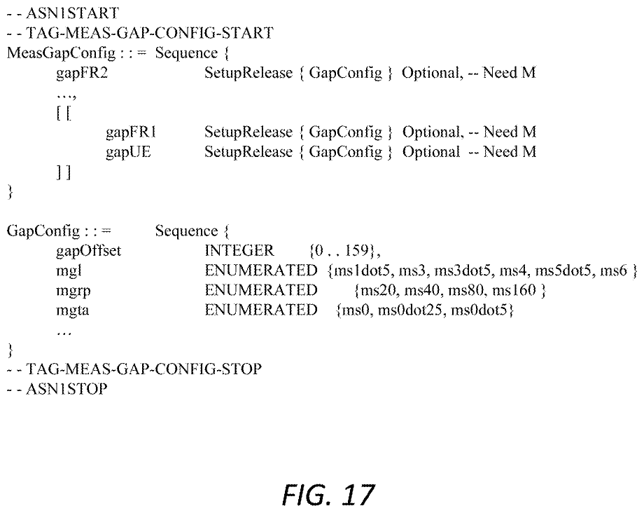

In some embodiments, the UE may be configured to make FR1 measurements and/or FR2 measurements during measurement gaps, e.g., as determined by a measurement gap configuration transmitted by the network via a base station (e.g., an eNB of 3GPP LTE, or a gNB of 5G NR). The measurement gap configuration may be provided by the network as part of data structure including parameters such as gap length, offset, repetition and timing advance. As shown in FIG. 16, measurement gap configuration 1602 may include per-UE gap configuration 1604 or per-FR gap configuration 1606. The per-UE gap configuration may define one gap to measure frequencies in FR1 and FR2; may be provided by the master node (MN) in a NSA scenario. (NSA is an acronym for Non-StandAlone.) The UE may determine how to apply the gap. The per-FR gap configuration 1606 may include configuration 1608 defining an FR1 gap and configuration 1610 defining an FR2 gap. The FR1 gap configuration 1608 may define a gap for measurement on FR1 or FR_{LTE}, and may be provided by the master node in the NSA scenario. The FR2 gap configuration 1610 may define a gap for measurement on FR2, and may be provided by the secondary node (SN) in the NSA scenario.

In some embodiments, in an EN-DC scenario, the UE may be configured either with a single (common) gap or with two separate gaps—i.e. a first gap for FR1 (configured by E-UTRA RRC) and a second gap for FR2 (configured by NR RRC). RRC is an acronym for Radio Resource control.

In some embodiments, during the per-UE measurement gaps the UE: is not required to conduct reception/transmission from/to the corresponding EUTRAN PCell, E-UTRAN SCell(s) and NR serving cells for NSA except the reception of signals used for RRM measurement; and is not required to conduct reception/transmission from/to the corresponding NR serving cells for SA except the reception of signals used for RRM measurement. (PCell is an acronym for Primary Cell. SCell is an acronym for Secondary Call. RRM is an acronym for Radio Resource Management.)

In some embodiments, during the per-FR measurement gaps the UE: is not required to conduct reception/transmission from/to the corresponding EUTRAN PCell, E-UTRAN SCell(s) and NR serving cells in the corresponding frequency range for NSA except the reception of signals used for RRM measurement; and is not required to conduct reception/transmission from/to the corresponding NR serving cells in the corresponding frequency range for SA except the reception of signals used for RRM measurement.

In some embodiments, a data structure for a measurement gap configuration message may be defined as shown in FIG. 17. The field parameters for the data structure may be defined as follows.

The field gapFR1 indicates measurement gap configuration that applies to FR1 only. In the case of EN-DC, gapFR1 is preferably not set up by NR RRC (i.e., LTE RRC configures FR1 gap). gapFR1 is preferably not configured together with gapUE. The applicability of the measurement gap may be according to Table 9.1.2-2 in 3GPP TS 38.133, v.15.7.0.

The field gapFR2 indicates measurement gap configuration that applies to FR2 only. gapFR2 is preferably not configured together with gapUE. The applicability of the measurement gap may be according to Table 9.1.2-1 and Table 9.1.2-2 in 3GPP TS 38.133, v.15.7.0.

The field gapUE indicates measurement gap configuration that applies to all frequencies (FR1 and FR2). In the case of EN-DC, gapUE is preferably not set up by NR RRC (i.e., LTE RRC configures per UE gap). In some embodiments, if gapUE is configured, then neither gapFR1 nor gapFR2 are configured. The applicability of the measurement gap may be according to Table 9.1.2-2 in 3GPP TS 38.133, v.15.7.0.

The value gapOffset is the gap offset of the gap pattern with MGRP indicated in the field mgrp. The value range of the gapOffset may be from 0 to mgrp-1.

The value mg1 is the measurement gap length of the measurement gap, e.g., in milliseconds. The applicability of the measurement gap may be according to Table 9.1.2-1 and Table 9.1.2-2 in 3GPP TS 38.133, v.15.7.0. Value ms1dot5 corresponds to 1.5 ms; ms3 corresponds to 3 ms; and so on. The given set of possible values for mg1 is illustrative, and may vary in different contexts and application scenarios.

The value mgrp is a measurement gap repetition period in (ms) of the measurement gap. The applicability of the measurement gap may be according to Table 9.1.2-1 and Table 9.1.2-2 in 3GPP TS 38.133, v.15.7.0. The given set of possible values for mgrp is illustrative, and may vary in different contexts and application scenarios.

The value mgta is the measurement gap timing advance in milliseconds (ms). The applicability of the measurement gap timing advance may be according to clause 9.1.2 of TS 38.133, v.15.7.0. Value ms0 corresponds to 0 ms; ms0dot25 corresponds to 0.25 ms; and ms0dot5 corresponds to 0.5 ms. For FR2, the network only configures 0 and 0.25 ms. The given set of possible values for mgta is illustrative, and may vary in different contexts and application scenarios.

In some embodiments, the UE may employ the following algorithm for controlling measurements. In response to determining that the UE is in a low power mode and the UE's battery has less than BP_{LOW} power remaining and the UE is in a state motion, the UE may determine whether a per-UE measurement gap is configured or if per-FR measurement gap information is configured. (The battery power threshold BP_{Low} may take any of a wide variety of values, e.g., 20% in one embodiment.) If a per-UE measurement gap is configured, the UE may scan only E-UTRA frequencies and/or FR1 frequencies during the measurement gap, and avoid scanning FR2 during the measurement gap. If per-FR measurement gap is configured, the UE may avoid scanning FR2 during FR2 measurement gap if an FR2 measurement gap is configured, and perform measurements on FR1 or FR_{LTE} according to measurement configuration parameters received from network if an FR1 measurement gap is configured.

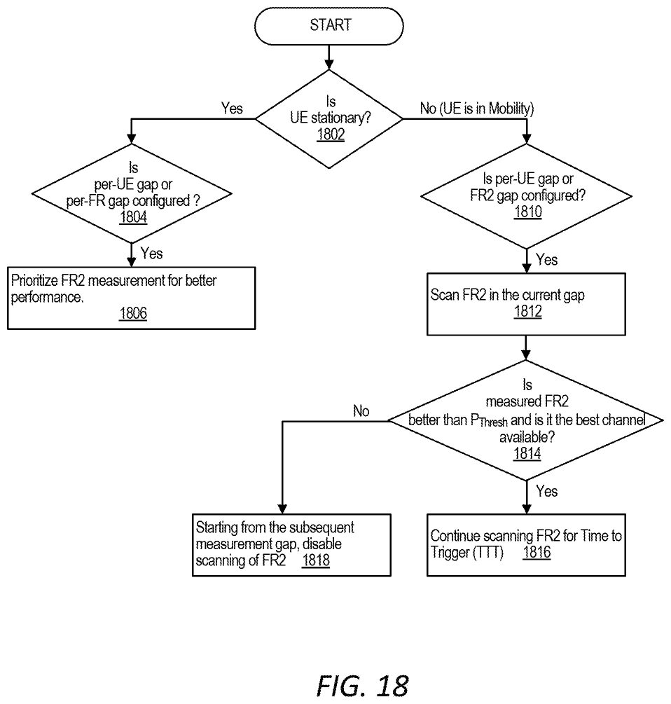

In some embodiments, a UE may employ the algorithm of FIG. 18 for controlling measurements in response to determining that UE's battery has more than BP_{LOW} power remaining or the UE is connected to power source. At 1802, the UE may determine if the UE is stationary (not moving, or moving less than a threshold amount). If so, the UE may proceed to 1804. If not, the UE may proceed to 1810.

At 1804, the UE may determine if measurement gap is configured in a per-UE fashion or a per-FR fashion. If so, the UE may prioritize FR2 measurements for better performance (e.g., for higher bandwidth and data rates), as indicated at 1806.

If the UE is in a state of motion (i.e., not stationary), the UE may determine if per-UE measurement gap or FR2 measurement gap is configured, as indicated at 1810. If so, the UE may scan FR2 in a current measurement gap, as indicated at 1812.

At 1814, the UE may then determine if a measured FR2 cell is stronger than P_{Thresh} and is the best available channel. (Note that the power threshold P_{Thresh} may take any of a wide variety of values, e.g., −110 dBm in one embodiment.) If so, the UE may continue scanning FR2 for a time to trigger (TTT), as indicated at 1816. (The UE may send a measurement report for the FR2 cell when its signal strength remains greater than P_{Thresh} for a continuous duration of TTT milliseconds. The network may respond by sending a handover command HO.) If not, the UE may disable scanning of FR2 starting with the subsequent measurement gap (i.e., the gap after the current gap), as indicated at 1818.

### Disabling FR2 Measurements Based on Weather Conditions

The millimeter wave (mmWave) band suffers high attenuation when blocked by any of various objects. Water also attenuates the millimeter wave signal strength significantly. Thus, when the UE is located in an area that is undergoing rain and/or snow, the UE may disable (or de-prioritize) FR2 measurements to improve user experience.

In some embodiments, the UE may determine if the UE in a geographical area that is experiencing heavy rain or snow fall, e.g., by interrogating a weather service provider. (The UE may provide its GPS location to the weather server, and the server may send a response message indicating the weather conditions at the UE location. In an alternative embodiment, the UE may determine local weather conditions by analyzing audio signals from the UE's microphone or RF signals acquired from the UE's antennas. In another alternative embodiment, a base station, e.g., an eNB or gNB, may provide local weather information to the UE.) If the UE is in a geographical area that is experiencing heavy rain or snow fall, the UE may disable FR2 measurements and make the UE camp to FR1 in SA or FR_{LTE} in NSA mode. If the UE is not in such a geographical region, the UE may enable both FR1 and FR2 measurements.

### FR2 Preference Derivation Based on Sensing Information

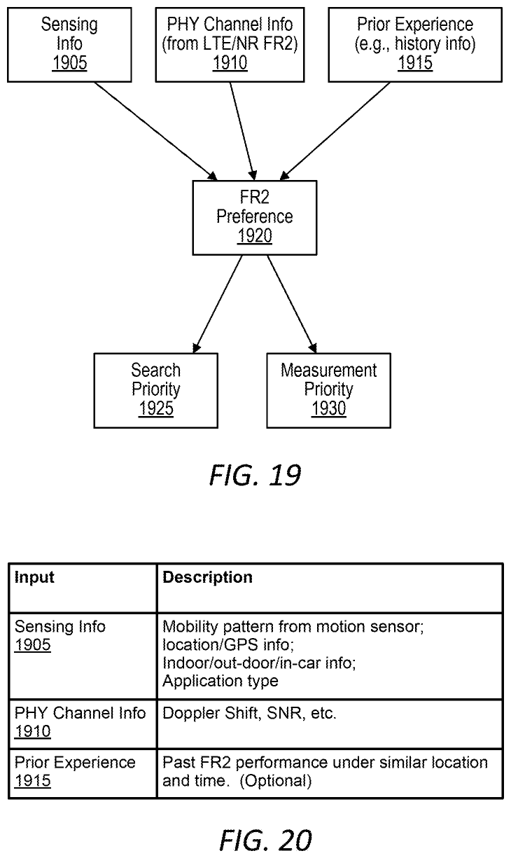

In some embodiments, the derivation of FR2 preference may be based on sensing information, or sensing information in combination with other inputs. For example, as shown in FIG. 19, a UE may determine an extent of FR2 preference 1920 (over FR1 or FR_{LTE}) based on one or more of the following inputs: sensing information 1905, physical (PHY) channel information 1910 (from the LTE frequency range or NR FR2), and prior experience information 1915 (e.g., history information). The FR2 preference value 1920 may be used to control a search priority 1925 and/or a measurement priority 1930, e.g., as various descried herein.

FIG. 20 illustrates examples for the sensing information 1905, physical channel information 1910 and prior experience 1915. The sensing information 1905 may include one or more of the following: a mobility pattern (or indicator of extent of mobility) from motion sensor; location information (e.g., GPS location); indication of whether the UE is in an indoor environment or outdoor environment; indication of whether the UE is in an automobile or not; an indication of the type of application executing on the UE; an indication of the bandwidth and/or stability requirements of an application executing on the UE. The PHY channel information 1910 may include Doppler shift, Signal to Noise Ratio (SNR), Signal to Interference-and-Noise Ratio (SINR), etc. The prior experience 1915 may include past FR2 performance under similar location and time conditions as the present location and time condition.

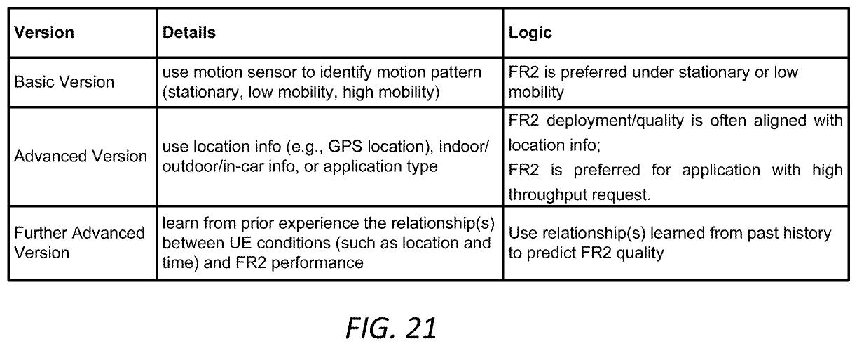

In some embodiments, a mechanism for deriving an extent of FR2 preference based on input information may be implemented as various described in FIG. 21.

In a basic version of the mechanism, the UE may use a motion sensor to identify motion pattern (stationary, low mobility, high mobility) of the UE. FR2 may be preferred in the stationary condition or low mobility condition.

In an advanced version of the mechanism, the UE may use location information (e.g., GPS location), indoor/outdoor/in-car info, or application type to determine extent of FR2 reference. FR2 deployment/quality is often correlated with location information. FR2 may be preferred for an application with high throughput request. In some embodiments, the UE may determine that it is in an indoor environment by any of various means, e.g., by determining if it is connected to an indoor WiFi or an indoor home-pod, or if its current location is within the geographical bounds of a known indoor environment. In some embodiments, the UE may determine that it is within an in-car environment by determining if it is connected to a car Bluetooth modem.

In a further advanced version of the mechanism, the UE may learn from prior experience the relationship between measured conditions (such as location and time) and extent of FR2 performance. (Time expressed in any of various ways. For example, in one embodiment, time may be expressed as a vector <Year, Month, Day of Month, Time of Day>.) The learned relationship may be used to predict FR2 quality or extent of FR2 preference under present conditions (e.g., present location and time).

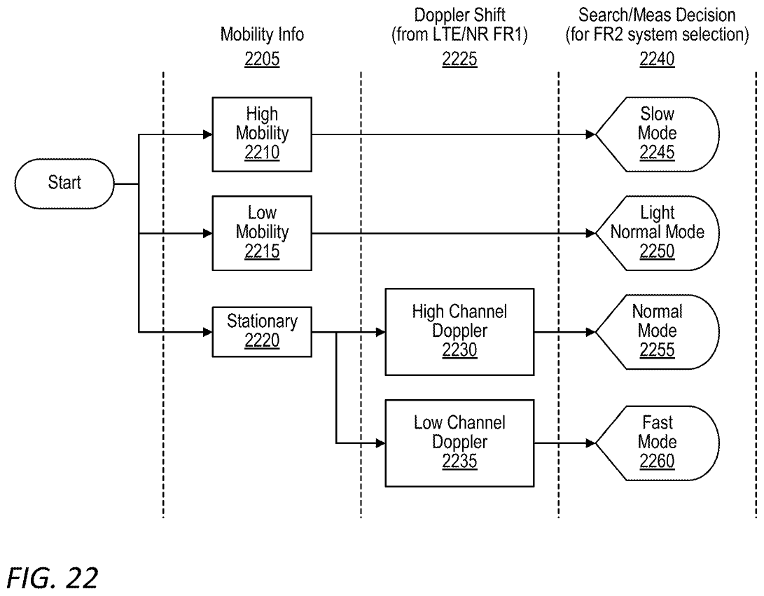

In some embodiments, the UE may determine a mode of FR2 search and/or measurement based on mobility information 702 and Doppler shift information 704, e.g., as shown in FIG. 22. The UE may determine a state of mobility based on the mobility information. Mobility may have at least three possible states: a high mobility state 2210, a low mobility state 2215 and a stationary state 2220. The UE may employ Doppler shift information from physical channel measurements in the LTE frequency range or NR FR1 to determine whether the stationary state 2220 corresponds to a high channel Doppler state 2230 or a low channel Doppler state 2235. The UE may then assign the high mobility state to a slow mode 2245, the low mobility state 2215 to a light normal mode 2250, the high channel Doppler state 2230 to a normal mode 2255, and the low channel Doppler state 2235 to a fast mode 2260. These modes may correspond to respective values of search period and respective values of measurement period, e.g., as shown in FIG. 13. The UE accesses the search period and measurement period corresponding to the presently determined mode, and implements search and measurement processes on FR2 based on the accessed periods. Thus, in the present embodiment, the extent of FR2 preference is expressed in terms of rates of FR2 search and measurement, with higher rates (smaller periods) corresponding to higher FR2 preference relative to FR_{LTE} or FR1.

### Disable FR2 Measurements Based on IMS (IP Multimedia Subsystem) Support

The millimeter wave range of the electromagnetic spectrum is vulnerable to blocking and shading. For example, in some circumstances, signal strength in the FR2 frequency range of 5G NR may drop as much as 50 dB when moving across streets in a city, e.g., due to buildings coming into the line of sight between the gNB and UE. Thus, in some embodiments, the UE may disable FR2 measurements in response to determining that a voice call is active (or to be initiated). The disabling of FR2 measurements may provide the user with a better experience, e.g., fewer losses of connection or degradations of call quality.

In some embodiments, the UE may determine if Voice Over NR (VoNR) supports is available only in FR1. If so, the UE may disable FR2 measurements when a voice call is active. Alternatively, in response to determining that VoNR is supported in FR1 and FR2, the UE may determine if the UE is in a state of motion and if a voice call is active. If both conditions are satisfied, the UE may disable FR2 measurements.

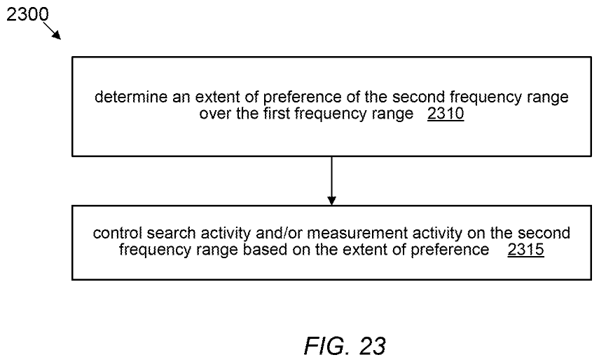

In some embodiments, a method 2300 for operating a wireless user equipment (UE) device may include the operations shown in FIG. 23. (The method 2300 may also include any subset of the elements, embodiments and features described above in connection with FIGS. 1-22.) The wireless UE device may be configured as variously described above, e.g., as described in connection with user equipment 600 of FIG. 6. The UE device may be configured to support communication over a first frequency range and a second frequency range with the second frequency range being higher in frequency than the first frequency range. In some embodiments, the first frequency range may be the frequency range as defined by 3GPP LTE or the frequency range FR1 defined by 5G NR; and the second frequency range may be the frequency range FR2 defined by 5G NR. The method 2300 may be performed by a processing element of the UE device.

At 2310, the processing element may determine an extent of preference of the second frequency range over the first frequency range, e.g., as variously described above.

At 2320, the processing element may control search activity and/or measurement activity on the second frequency range based on the extent of preference, e.g., as variously described above.

In some embodiments, said controlling may include adjusting a period of the search activity on the second frequency range based on the extent of preference, where the period is a decreasing function of the extent of preference, e.g., as variously described above.

In some embodiments, said controlling may include adding a measurement bias to a minimum value threshold that used to trigger reporting of a measurement on the second frequency range to a network. The measurement bias may be a decreasing function of the extent of preference.

In some embodiments, said controlling may include adding a delay to a reporting time of a measurement on the second frequency range. The delay may be a decreasing function of the extent of preference.

In some embodiments, the extent of preference has two or more possible values (or states).

In some embodiments, the extent of preference may be determined based at least on one or more indicators of condition of the UE's battery, e.g., as variously described above.

In some embodiments, the extent of preference may be determined based at least on whether the UE device is in an idle mode or in a connected mode with respect to a wireless communication network.

In some embodiments, the extent of preference may be determined based at least on whether an average transmit power over n most recent measurement samples is greater than one or more power thresholds, e.g., as variously described above. The value n is a positive integer, and may take any of a wide variety values.

In some embodiments, the extent of preference may be determined based at least on an extent of motion of UE device, e.g., translational motion and/or rotational motion.

In some embodiments, the extent of preference may be based at least on a number of handovers relating to the second frequency range that have occurred within a given amount of time, e.g., the last X units of time as described above. The given amount of time may be determined by configuration information received from a base station (e.g., an eNB of 3GPP LTE, or a gNB or 5G NR).

In some embodiments, the extent of preference may be based at least on a result of a comparison of RF condition on the second frequency range to RF condition on the first frequency range. RF condition may be measured in any of various ways in different embodiments, e.g., by measurement of RSRP (Reference Signal Receiver Power).

In some embodiments, the processing element may also receive a configuration message from a base station, wherein the configuration message includes information indicating a measurement gap for measurements on the second frequency range. The action 2315 of controlling search activity and/or measurement activity may include avoiding said search activity on the second frequency range during the measurement gap in response to a determination that the UE device is in a state of motion and/or in a state of low battery power, e.g., as variously described above.

In some embodiments, the processing element may receive a configuration message from a base station, wherein the configuration message includes information indicating a common measurement gap for the first frequency range and the second frequency range. The action 2315 may include, during the measurement gap, searching the first frequency range and avoiding (or disabling) search on the second frequency range, in response to a determination that the UE device is in a state of motion and/or in a state of low battery power, e.g., as variously described above.

In some embodiments, the action 2315 may include prioritizing measurements on the second frequency range over measurements on the first frequency range during measurement gaps in response to determination that the UE device is in a stationary state and in not in a state of low battery power, e.g., as variously described above.

In some embodiments, the action 2315 may include, in response to determining that the UE device is in a state of motion and not in a state of low battery power: (a) scanning the second frequency range during a current measurement gap to determine signal condition on the second frequency range; and (b) in response to determining that signal condition on the second frequency range satisfies one or more quality conditions, continue scanning the second frequency range for time to trigger (TTT) for network to send handover command.

In some embodiments, the extent of preference may be determined based at least on an indication of one or more weather conditions, e.g., an indication that the UE is located in a geographical area that is experience heavy rain or snowfall.

In some embodiments, the extent of preference is determined based at least on sensing information acquired by the UE device, wherein the sensing information includes one or more of the following: an extent of motion of the UE device; location of the UE device; an indication of indoor/outdoor status of the UE device; an indication of whether the UE device is in an automobile or not; an indication of type of application being executed on the UE device; an extent of Doppler shift of the UE device relative to a base station; measurement of signal quality on the second frequency range and/or the first frequency range; history of past performance of the second frequency range in location-time conditions similar to present location-time conditions.

In some embodiments, the extent of preference may be determined based at least on whether a voice call is active on the UE device, e.g., a Voice over NR call as described above.

In some embodiments, the second frequency range includes one or more millimeter wave frequency bands.

In some embodiments, the UE may be configured to support communication on the first frequency range using a first radio access technology (such as 3GPP LTE) and communication on the second frequency range using a second radio access technology (such as 5G NR) different from the first radio access technology.

In some embodiments, the UE may be configured to support communication on the first frequency range and the second frequency range using the same radio access technology (e.g., 5G NR).

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a user equipment (UE) device, a tablet computer, a wearable computer, a computer implanted in a biological organism, etc.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for operating a user equipment (UE) device that is configured to support communication over a first frequency range and a second frequency range with the second frequency range being higher in frequency than the first frequency range, the method comprising:
determining an extent of preference of the second frequency range over the first frequency range; and
controlling search activity and/or measurement activity on the second frequency range based on the extent of preference.

2. The method of claim 1, wherein said controlling includes adjusting a period of said search activity on the second frequency range based on the extent of preference, wherein the period is a decreasing function of the extent of preference.

3. The method of claim 1, wherein said controlling includes adding a measurement bias to a minimum value threshold that used to trigger reporting of a measurement on the second frequency range to a network, wherein the measurement bias is a decreasing function of the extent of preference.

4. The method of claim 1, wherein said controlling includes adding a delay to a reporting time of a measurement on the second frequency range, wherein the delay is a decreasing function of the extent of preference.

5. (canceled)

6. The method of claim 1, wherein the extent of preference is determined based at least on one or more indicators of condition of the battery of the UE device.

7. The method of claim 6, wherein the extent of preference is determined based at least on whether the UE device is in an idle mode or in a connected mode with respect to a wireless communication network.

8. The method of claim 6, wherein the extent of preference is determined based at least on:
whether an average transmit power over n most recent measurement samples is greater than one or more power thresholds; or
an extent of motion of UE device; or
a number of handovers relating to the second frequency range that have occurred within a given amount of time; or
a result of a comparison of RF condition on the second frequency range to RF condition on the first frequency range.

9-11. (canceled)

12. The method of claim 1, further comprising receiving a configuration message from a base station, wherein the configuration message includes information indicating a measurement gap for measurements on the second frequency range, wherein said controlling includes avoiding said search activity on the second frequency range during the measurement gap in response to a determination that the UE device is in a state of motion and/or in a state of low battery power.

13. The method of claim 1, further comprising receiving a configuration message from a base station, wherein the configuration message includes information indicating a common measurement gap for the first frequency range and the second frequency range, wherein said controlling includes, during the measurement gap, searching the first frequency range and avoiding search on the second frequency range, in response to a determination that the UE device is in a state of motion and/or in a state of low battery power.

14. The method of claim 1, wherein said controlling includes prioritizing measurements on the second frequency range over measurements on the first frequency range during measurement gaps in response to determination that the UE device is in a stationary state and in not in a state of low battery power.

15. The method of claim 1, wherein said controlling includes, in response to determining that the UE device is in a state of motion and not in a state of low battery power:
scanning the second frequency range during a current measurement gap to determine signal condition on the second frequency range;
in response to determining that signal condition on the second frequency range satisfies one or more quality conditions, continue scanning the second frequency range for time to trigger (TTT) for network to send handover command.

16. The method of claim 1, wherein the extent of preference is determined based at least on an indication of one or more weather conditions.

17. The method of claim 1, wherein the extent of preference is determined based at least on sensing information acquired by the UE device, wherein the sensing information includes one or more of the following:
an extent of motion of the UE device;
location of the UE device;
an indication of indoor/outdoor status of the UE device;
an indication of whether the UE device is in an automobile or not;
an indication of type of application being executed on the UE device;
an extent of Doppler shift of the UE device relative to a base station;
measurement of signal quality on the second frequency range and/or the first frequency range;
history of past performance of the second frequency range in location-time conditions similar to present location-time conditions.

18. The method of claim 1, wherein the extent of preference is determined based at least on whether a voice call is active on the UE device.

19. The method of claim 1, wherein the second frequency range includes one or more millimeter wave frequency bands, wherein the UE device is configured to support communication on the first frequency range using a first radio access technology and communication on the second frequency range using a second radio access technology different from the first radio access technology.

20. The method of claim 1, wherein the second frequency range includes one or more millimeter wave frequency bands, wherein the UE device is configured to support communication on the first frequency range and the second frequency range using the same radio access technology.

21. A user equipment (UE) device configured to support communication over a first frequency range and a second frequency range with the second frequency range being higher in frequency than the first frequency range, wherein the UE device comprises:
a processing element configured to perform operations including:
determining an extent of preference of the second frequency range over the first frequency range; and
controlling search activity and/or measurement activity on the second frequency range based on the extent of preference.

22. The UE device of claim 21, wherein the second frequency range includes one or more millimeter wave frequency bands, wherein the UE device is configured to support communication on the first frequency range using a first radio access technology and communication on the second frequency range using a second radio access technology different from the first radio access technology.

23. The UE device of claim 1, wherein the second frequency range includes one or more millimeter wave frequency bands, wherein the UE device is configured to support communication on the first frequency range and the second frequency range using the same radio access technology.

24. A non-transitory memory medium for a user equipment (UE) device storing program instructions, wherein the UE device is configured to support communication over a first frequency range and a second frequency range with the second frequency range being higher in frequency than the first frequency range, wherein the program instructions, when executed by a processing element, cause the processing element to implement:
determining an extent of preference of the second frequency range over a first frequency range relative to a second frequency range, wherein the second frequency range is higher in frequency than the first frequency range; and
controlling search activity and/or measurement activity on the second frequency range based on the extent of preference.

25-26. (canceled)
